(19) United States
(12) Patent Application Publication
(10) Pub. No.: US 2013/0324144 A1
(43) Pub. Date: Dec. 5, 2013

(54) Apparatus and Method for Controlling Wireless Downlink and Uplink Transmission

(71) Applicant: Markus WARKEN, Laupheim (DE)

(72) Inventor: Markus WARKEN, Laupheim (DE)

(73) Assignee: Nokia Siemens Networks Oy, Espoo (FI)

(21) Appl. No.: 13/996,017

(22) PCT Filed: Dec. 20, 2010
(86) PCT No.: PCT/EP2010/070300

§ 371 Date: Jul. 29, 2013

(51) Int. Cl. H04W 72/04

(52) U.S. Cl. CPC H04W 72/042
USPC 455/452.1

(57) ABSTRACT

Apparatus and method for communication are provided. The method includes controlling transmission to user equipment in downlink direction by monitoring the amount of data to be transmitted to the user equipment and monitoring the time elapsed since the previous downlink transmission of the user equipment and allowing data transmission only when either result of monitoring exceeds a predetermined threshold; and controlling transmission from user equipment in uplink direction by allowing the user equipment to start uplink transmission only when a given predetermined time interval has elapsed since the previous uplink transmission from the user equipment

### FIELD

The exemplary and non-limiting embodiments of the invention relate generally to wireless communication networks and, more particularly, to an apparatus and a method in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

Wireless communication systems are constantly under development. Developing systems provide a cost-effective support of high data rates and efficient resource utilization. One communication system under development is the 3rd Generation Partnership Project (3GPP) Long Term Evolution (LTE) Release 8. An improved version of the Long Term Evolution radio access system is called LTE-Advanced (LTE-A). The LTE and LTE-A are designed to support various services, such as high-speed data.

Modern user equipment support many different kind of services and applications. A typical user of modern user equipment (sometimes called a smartphone) may run several applications simultaneously, where the applications require a permanent Internet connection. However, the actual data volume that is transferred is on average very small. This effect is increased by the fact that the data traffic generated by these applications is uncorrelated. Thus, the user equipment may have many active simultaneous connections with virtually no traffic.

A base station or eNodeB having several smartphones in its area needs to maintain a comparable high number of user equipment in connected state as a consequence of above. This causes not only a high static load as resources need to be reserved for the connected user equipment, but also a high dynamical load due to handovers, measurements, etc in the Control Plane. A high static load in the network side of the system comes on top as many active bearers need to be maintained.

For LTE this is particularly crucial as there is no controller like Radio Network Controller RNC in UMTS (Universal Mobile Telecommunications System) or Base Station Controller BSC in GPRS (General Packet Radio Service). The Call Processing of the radio access network is done in the eNodeB that is deployed in very high numbers. Thus, the hardware cost dominates the business case and makes it very expensive to add further hardware to increase the Control Plane power.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus comprising: at least one processor and at least one memory including a computer program code, the at least one memory and the computer program code configured to, with the at least one processor, cause the apparatus at least to: control transmission to user equipment in downlink direction by monitoring the amount of data to be transmitted to the user equipment and monitoring the time elapsed since the previous downlink transmission of the user equipment and allowing data transmission only when either result of monitoring exceeds a predetermined threshold; and control transmission from user equipment in uplink direction by allowing the user equipment to start uplink transmission only when a given predetermined time interval has elapsed since the previous uplink transmission from the user equipment.

According to an aspect of the present invention, there is provided a method comprising: controlling transmission to user equipment in downlink direction by monitoring the amount of data to be transmitted to the user equipment and monitoring the time elapsed since the previous downlink transmission of the user equipment and allowing data transmission only when either result of monitoring exceeds a predetermined threshold; and controlling transmission from user equipment in uplink direction by allowing the user equipment to start uplink transmission only when a given predetermined time interval has elapsed since the previous uplink transmission from the user equipment. According to an aspect of the present invention, there is provided an apparatus comprising: at least one processor and at least one memory including a computer program code, the at least one memory and the computer program code configured to, with the at least one processor, cause the apparatus at least to: enter on the basis of a command from a base station a forced idle state, in which state the apparatus may request a connection only after a predetermined time interval has elapsed since previous transmission or if the amount of data to be transmitted by the apparatus is larger than a predetermined threshold.

According to an aspect of the present invention, there is provided a method comprising: receiving a command from a base station; entering on the basis of the command a forced idle state, in which state the apparatus may request a connection only after a predetermined time interval has elapsed since previous transmission or if the amount of data to be transmitted by the apparatus is larger than a predetermined threshold.

According to another aspect of the present invention, there is provided a computer program embodied on a distribution medium, comprising program instructions which, when loaded into an electronic apparatus, control the apparatus to: control transmission to user equipment in downlink direction by monitoring the amount of data to be transmitted to the user equipment and monitoring the time elapsed since the previous downlink transmission of the user equipment and allowing data transmission only when either result of monitoring exceeds a predetermined threshold; and control transmission from user equipment in uplink direction by allowing the user equipment to start uplink transmission only when a given predetermined time interval has elapsed since the previous uplink transmission from the user equipment.

According to yet another aspect of the present invention, there is provided a computer program embodied on a distribution medium, comprising program instructions which, when loaded into an electronic apparatus, control the apparatus to: enter on the basis of a command from a base station a forced idle state, in which state the apparatus may request a connection only after a predetermined time interval has elapsed since previous transmission or if the amount of data to be transmitted by the apparatus is larger than a predetermined threshold.

### LIST OF DRAWINGS

Embodiments of the present invention are described below, by way of example only, with reference to the accompanying drawings, in which

FIG. 1 shows a simplified block diagram illustrating an example of a system architecture;

FIG. 2A illustrates an example of an eNodeB;

FIG. 2B illustrates an example of user equipment;

FIGS. 3A and 3B are flow charts illustrating embodiments; and

FIGS. 4A, 4B and 4C flow charts illustrating embodiments of the invention.

### DESCRIPTION OF SOME EMBODIMENTS

Exemplary embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments of present invention are applicable to any network element, node, base station, server, corresponding component, and/or to any communication system or any combination of different communication systems that support required functionalities. The communication system may be a wireless communication system or a communication system utilizing both fixed networks and wireless networks. The protocols used and the specifications of communication systems, servers and user terminals, especially in wireless communication, develop rapidly. Such development may require extra changes to an embodiment. Therefore, all words and expressions should be interpreted broadly and are intended to illustrate, not to restrict, the embodiment.

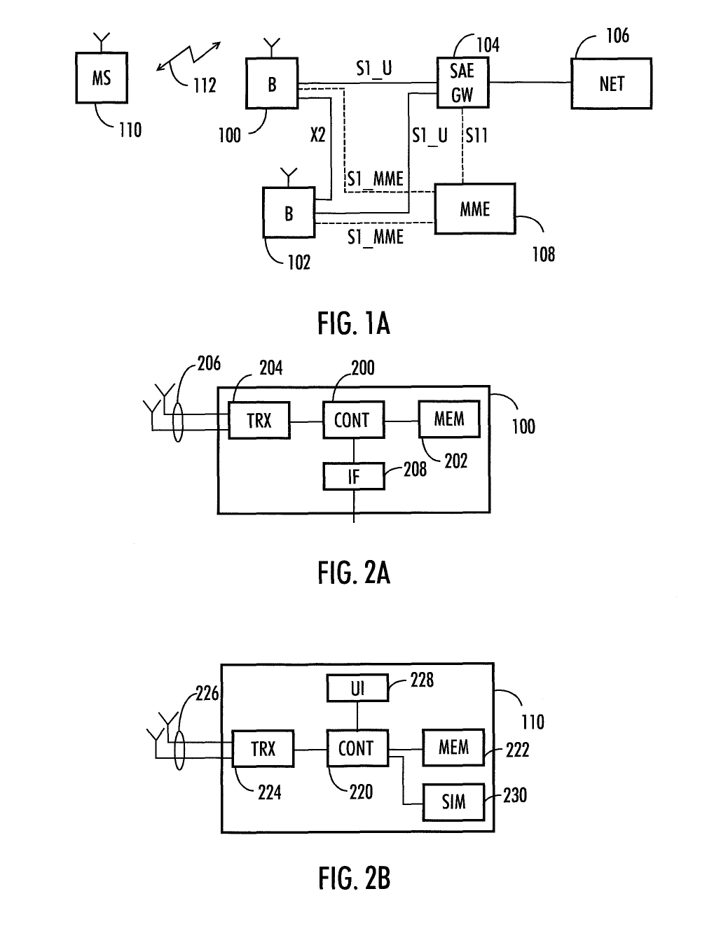

With reference to FIG. 1, let us examine an example of a radio system to which embodiments of the invention can be applied. In this example, the radio system is based on LTE network elements. However, the invention described in these examples is not limited to the LTE radio systems but can also be implemented in other radio systems.

A general architecture of a communication system is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements, and protocols used in or for group communication are irrelevant to the actual invention. Therefore, they need not be discussed in more detail here. The exemplary radio system of FIG. 1 comprises a service core of an operator including the following elements: an MME (Mobility Management Entity) 108 and an SAE GW (SAE Gateway) 104. It should be appreciated that the communication system may also comprise other core network elements besides SAE GW 104 and MME 108.

Base stations that may also be called eNodeBs (Enhanced node Bs) 100, 102 of the radio system may host the functions for Radio Resource Management: Radio Bearer Control, Radio Admission Control, Connection Mobility Control, Dynamic Resource Allocation (scheduling). The MME 108 is responsible for distributing paging messages to the eNodeBs 100, 102. The eNodeBs are connected to the SAE GW with an S1_U interface and to MME with an S1_MME interface. The eNodeBs may communicate with each other using an X2 interface. The SAE GW 104 is an entity configured to act as a gateway between the network and other parts of communication network such as the Internet 106, for example. The SAE GW may be a combination of two gateways, a serving gateway (S-GW) and a packet data network gateway (P-GW).

FIG. 1 illustrates user equipment UE 110 located in the service area of the eNodeB 100. User equipment refers to a portable computing device. Such computing devices include wireless mobile communication devices, including, but not limited to, the following types of devices: mobile phone, smartphone, personal digital assistant (PDA), handset, laptop computer. The apparatus may be battery powered.

In the example situation of FIG. 1, the user equipment 110 has a connection 112 with the eNodeB 100. The connection 112 may be a bidirectional connection related to a speech call or a data service such as browsing the Internet 106.

FIG. 1 only illustrates a simplified example. In practice, the network may include more base stations and more cells may be formed by the base stations. The networks of two or more operators may overlap; the sizes and form of the cells may vary from what is depicted in FIG. 1, etc.

The embodiments are not restricted to the network given above as an example, but a person skilled in the art may apply the solution to other communication networks provided with the necessary properties. For example, the connections between different network elements may be realized with Internet Protocol (IP) connections.

FIG. 2A illustrates an example of an eNodeB. The eNodeB 100 comprises a controller 200 operationally connected to a memory 202. The controller 200 controls the operation of the base station. The memory 202 is configured to store software and data. The eNodeB comprises a transceiver 204 configured to set up and maintain a wireless connection to user equipment within the service area of the base station on a given carrier. The transceiver 204 is operationally connected the controller 200 and to an antenna arrangement 206. The antenna arrangement may comprise a set of antennas. The number of antennas may be two to four, for example. The number of antennas is not limited to any particular number.

The base station may be operationally connected to other network elements of the communication system. The network element may be an MME (Mobility Management Entity), an SAE GW (SAE Gateway), a radio network controller (RNC), another base station, a gateway, or a server, for example. The base station may be connected to more than one network element. The base station 100 may comprise an interface 208 configured to set up and maintain connections with the network elements.

FIG. 2B illustrates examples of user equipment 110. The user equipment 110 comprises a controller 220 operationally connected to a memory 222 and a transceiver 224. The controller 220 controls the operation of the user equipment. The memory 222 is configured to store software and data. The transceiver 224 is configured to set up and maintain a wireless connection to an eNodeB on a given first carrier. The transceiver 224 is operationally connected to an antenna arrangement 226. The antenna arrangement may comprise a set of antennas. The number of antennas may be one to four, for example. As with the eNodeB, the number of antennas is not limited to any particular number.

The user equipment 110 may further comprise user interface 228. The user interface may comprise a speaker, a keyboard, a display, a microphone and a camera, for example. The user equipment 110 may further comprise a subscriber identity module (SIM) 230 on a removable SIM card, for example. The SIM stores the service-subscriber key, such as an International Mobile Subscriber Identity (IMSI) which is used to identify a subscriber on communication networks.

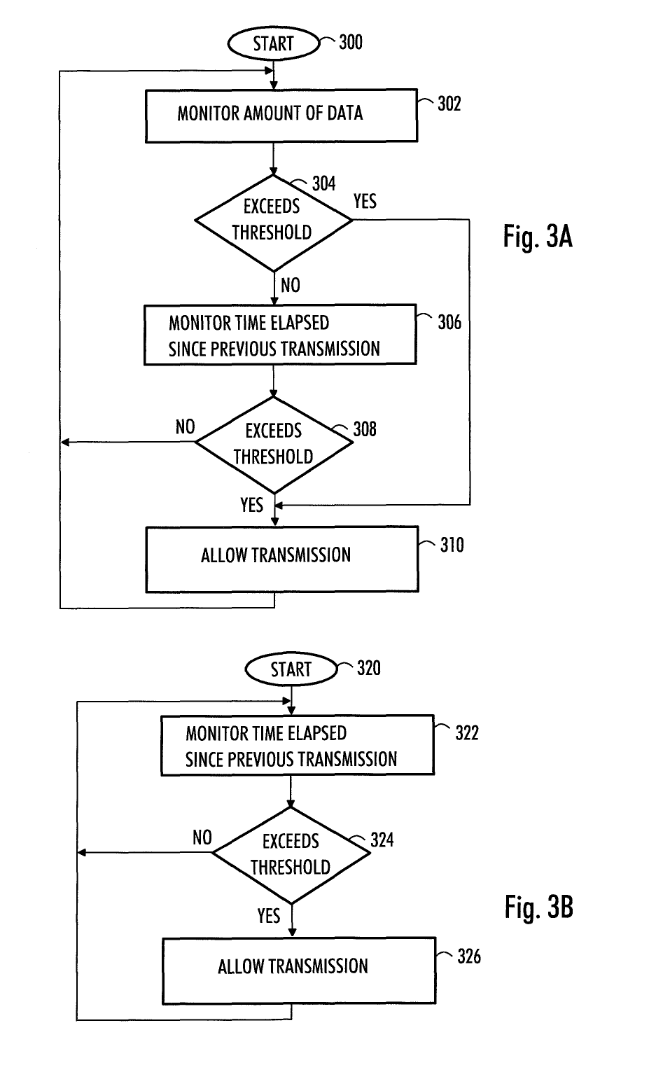

FIG. 3A is a flow chart illustrating an embodiment. In this embodiment, eNodeB controls the downlink transmission to user equipment. The embodiment starts at step 300.

In step 302, eNodeB 100 is configured to monitor the amount of data to be transmitted to the user equipment on downlink direction.

In step 304, the amount is compared to a predetermined threshold. If the amount of data to be transmitted to the user equipment exceeds the threshold, the process continues in step 310 by allowing downlink transmission to the user equipment.

If threshold is not exceeded, the time elapsed since the previous downlink transmission to the user equipment is monitored in step 306.

In step 308, the elapsed time is compared to a predetermined threshold. If the elapsed time exceeds the threshold, the process continues in step 310 by allowing downlink transmission to the user equipment. Otherwise, the process continues in step 302.

Above the data monitoring and time monitoring are described as sequential processes. However, the monitoring processes may also be executed in a reversed order or simultaneously.

FIG. 3B is another flow chart illustrating an embodiment. In this embodiment, eNodeB controls the uplink transmission from user equipment. The embodiment starts at step 320.

In step 322, the time elapsed since the previous uplink transmission from the user equipment is monitored.

In step 324, the elapsed time is compared to a predetermined threshold. If the elapsed time exceeds the threshold, the process continues in step 326 by allowing the user equipment to start uplink transmission.

Otherwise, the process continues in step 322.

In an embodiment, the user equipment is allowed to continue uplink transmission as long as the data throughput is above a given level. The transmission is discontinued when the throughput drops below the level, after which the process continues in step 322.

In an embodiment, the uplink and downlink transmissions are controlled on the basis of the type of the user equipment. For example, eNodeB may apply the proposed controlling only if the user equipment is a smartphone capable of running multiple applications requiring active connections to Internet. More simple equipment does not require controlling. In another embodiment, the uplink and downlink transmissions are controlled on the basis of the connection type of the user equipment. The user equipment may have only a speech call connection and no data connections active. In such a case transmission control may not be needed. Thus, even if the user equipment would be of the right type for the proposed controlling, the controlling is not applied if the connection type of the user equipment does not require it.

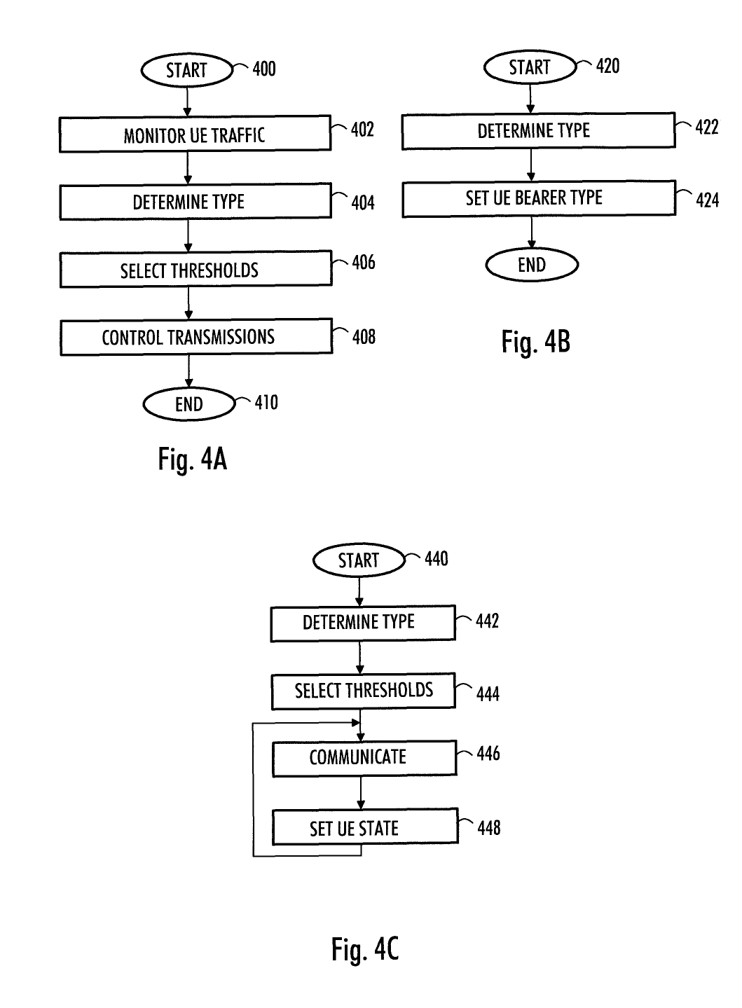

The flowchart of FIG. 4A illustrates an embodiment. In this example, the implementation is transparent to the user equipment and may be implemented in the eNodeB alone without requiring any standardisation or implementation in the user equipment or other parts of the communication network. The embodiment starts at step 400.

In step 402, the eNodeB monitors the data traffic of the user equipment. The eNodeB may obtain information of the data throughput of the bearer(s) of the user equipment and compare the results with predetermined thresholds. The operator of the network may select thresholds for time and data volume that define the type of the user equipment or the connection type of the user equipment.

In step 404, the eNodeB determines the type of the user equipment or the connection type of the user equipment on the basis of the comparison.

In step 406, the eNodeB may select thresholds for elapsed time and data volume to be applied in the controlling of the transmissions. The choice of the thresholds allows the operator to fine tune the radio resource usage: large volume and time thresholds might lead to a worse subscriber experience, but save a lot of radio resources and vice versa. The threshold selection may be based on the type of the user equipment or the type or properties of the connection of the user equipment.

In step 408, the eNodeB controls the transmissions as described above. For example, in downlink direction, data is only sent when either the volume threshold is exceeded or the time threshold is expired. In uplink direction, the eNodeB gives a sending grant to the user equipment request only after the expiration of an operator configured time threshold. Typically, the eNodeB will receive many transmit requests from the user equipment but respond with an acknowledgement only after the elapsed time exceeds the threshold.

In an embodiment, the uplink control may depend on the uplink data sent in the previous monitoring interval.

The process ends in step 410.

The flowchart of FIG. 4B illustrates an embodiment. In the embodiment, a new bearer type is introduced. The bearer type has both data volume and time thresholds assigned to user equipment. Data packages are sent only if a given data threshold is exceeded unless the time threshold is exceeded. This results in a smaller number of larger data packages. By this, the downlink traffic to a specific smartphone can be bundled. A similar gain can be achieved by discontinuous allowance of sending, i.e. giving uplink grants, for smartphones.

The embodiment starts at step 420.

In step 422, the eNodeB determines the type of the user equipment. The determination may be based on monitoring the data traffic of the user equipment. In an embodiment, the type may be determined based on user identification. For example, the IMEI (International Mobile Equipment Identity) may be used to identify the user equipment type. Each user equipment has a unique IMEI. The type of the user equipment indicates to the eNodeB which bearer types and states the user equipment supports.

In step 424, the eNodeB sets the bearer type of the user equipment. The bearer may be assigned to smart phones either in call setup or as soon as it can be identified as smartphone. Time and volume thresholds may be specific to the bearer type and signalled in call setup. This way, different categories of smartphones may be treated differently.

Provided the user equipment supports the new bearer type, it can actively request it in call setup. The most straightforward way to achieve this is via the subscriber contracts offered by the operator who offer very often customised user equipment. Most of the described additional measurements in the eNodeB can be avoided this way.

If the user equipment does provide the new bearer type, the eNodeB assigns the new bearer type to the user equipment as soon as the user equipment type is identified. This requires some time until the user equipment can be identified, but saves at least uplink signalling and also eNodeB internal measurements from then onwards.

In an embodiment, the parameters of the connection are right away set up in a way appropriate to the actual service request of the connection (low data rate, no severe timing constraints, for example). Otherwise the eNodeB would have to monitor the occurrence of transmissions for this bearer and the amount of data conveyed for this bearer for a while until it can decide on the appropriate parameter settings. Such a transient phase can be omitted when the user equipment requests a connection according to the suggested new bearer.

In an embodiment, the new bearer type is assigned to the user equipment only of the user equipment requires low data rate connection(s) without real-time constraints. If the user equipment needs a high data rate connection the use of the new bearer is not efficient.

The flowchart of FIG. 4C illustrates an embodiment. In the embodiment, a new user equipment state is introduced. In LTE, user equipment is either CONNECTED, i.e. can actively send or receive data, or IDLE. The connection setup times are about 100 ms, i.e. are very short in comparison to other technologies.

In an embodiment, a third UE state FORCED_IDLE is proposed. The state may be transparent for core network. When the eNodeB sends user equipment to FORCED_IDLE, the user equipment may only require a new connection after a given period of time unless a certain sufficient amount of data needs to be transferred.

This way, the number of active connections having virtually no traffic can be effectively reduced depending on the choice of the time threshold.

The embodiment starts at step 440.

In step 442, the eNodeB determines the type of the user equipment. The determination may be based on monitoring the data traffic of the user equipment. In an embodiment, the type may be determined based on user identification. For example, the IMEI (International Mobile Equipment Identity) may be used to identify the user equipment type. Each user equipment has a unique IMEI. The type of the user equipment indicates to the eNodeB which bearer types and states the user equipment supports.

In step 444, the eNodeB may select thresholds for elapsed time and data volume to be applied in the controlling of the transmissions. The choice of the thresholds allows the operator to fine tune the radio resource usage: large volume and time thresholds might lead to a worse subscriber experience, but save a lot of radio resources and vice versa.

In step 446, the eNodeB and user equipment communicate either in uplink or downlink direction or both.

In step 448, the eNodeB sets the user equipment into a FORCED_IDLE state in which state the apparatus may request a connection only after a predetermined time interval has elapsed since previous transmission or if the amount of data to be transmitted by the apparatus is larger than a predetermined threshold. In the FORCED_IDLE state the uplink transmission control is simplified as the user equipment will not try to request access but just wait until it will be allowed to send again, the process continuing in step 446. This saves signalling effort in the network.

The steps and related functions described above and in the attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

In an embodiment, the apparatus comprises means for controlling transmission to user equipment in downlink direction by monitoring the amount of data to be transmitted to the user equipment and monitoring the time elapsed since the previous downlink transmission of the user equipment and allowing data transmission only when either result of monitoring exceeds a predetermined threshold; and means for controlling transmission from user equipment in uplink direction by allowing the user equipment to transmit only when a given predetermined time interval has elapsed since the previous uplink transmission from the user equipment.

In an embodiment, the apparatus comprises means for receiving a command from a base station; and means for entering on the basis of the command a forced idle state, in which state the apparatus may request a connection only after a predetermined time interval has elapsed since previous transmission or if the amount of data to be transmitted by the apparatus is larger than a predetermined threshold.

It will be obvious to a person skilled in the art that, as technology advances, the inventive concept can be implemented in various ways. The invention and its embodiments are not limited to the examples described above but may vary within the scope of the claims.

1-28. (canceled)

29. An apparatus comprising:
at least one processor and at least one memory including a computer program code, the at least one memory and the computer program code configured to, with the at least one processor, cause the apparatus at least to:
control transmission to user equipment in downlink direction by monitoring the amount of data to be transmitted to the user equipment and monitoring the time elapsed since the previous downlink transmission of the user equipment and allowing data transmission only when either result of monitoring exceeds a predetermined threshold; and
control transmission from user equipment in uplink direction by allowing the user equipment to start uplink transmission only when a given predetermined time interval has elapsed since the previous uplink transmission from the user equipment.

30. The apparatus of claim 29, the apparatus being configured to determine the type of the user equipment and control the transmission only when the user equipment is of a predetermined type.

31. The apparatus of claim 29, the apparatus being configured to determine the type of connection the user equipment has with the apparatus and control the transmission only when the connection is of a predetermined type.

32. The apparatus of claim 30, the apparatus being configured to determine the type of the user equipment or the type of connection by monitoring the data throughput of the connection with the user equipment, and further configured to determine the type of connection the user equipment has with the apparatus and control the transmission only when the connection is of a predetermined type.

33. The apparatus of claim 29, the apparatus being configured to command the user equipment in a forced idle state, in which the user equipment may request a connection only after a predetermined time interval has elapsed since previous uplink transmission or if the amount of data to be transmitted by the user equipment is larger than a predetermined threshold.

34. The apparatus of claim 29, wherein the apparatus is configured to assign a bearer to user equipment, on which bearer transmission in downlink direction is controlled by a base station monitoring the amount of data to be transmitted to the user equipment and monitoring the time elapsed since the previous downlink transmission of the user equipment and allowing data transmission only when either result of monitoring exceeds a predetermined threshold; and
on which bearer transmission in uplink direction is controlled by the base station by allowing the user equipment to transmit only when a given predetermined time interval has elapsed since the previous uplink transmission from the user equipment.

35. The apparatus of claim 29, wherein the apparatus is configured to identify the connection type of the user equipment from the bearer type allocated to the user equipment; and
utilise information about the connection type when controlling the transmission of the user equipment.

36. The apparatus of claim 29, the apparatus being configured to
monitor the data throughput of the user equipment allowed to start uplink transmission;
compare the throughput to a given threshold; and command the user equipment to discontinue transmission when the throughput drops below the level.

37. An apparatus comprising:
at least one processor and at least one memory including a computer program code, the at least one memory and the computer program code configured to, with the at least one processor, cause the apparatus at least to:
enter on the basis of a command from a base station a forced idle state, in which state the apparatus may request a connection only after a predetermined time interval has elapsed since previous transmission or if the amount of data to be transmitted by the apparatus is larger than a predetermined threshold.

38. The apparatus of claim 37, configured to receive a bearer allocation from the base station, on which bearer transmission in downlink direction is controlled by base station monitoring the amount of data to be transmitted to the user equipment and monitoring the time elapsed since the previous downlink transmission of the user equipment and allowing data transmission only when either result of monitoring exceeds a predetermined threshold; and
on which bearer transmission in uplink direction is controlled by base station by allowing the user equipment to transmit only when a given predetermined time interval has elapsed since the previous uplink transmission from the user equipment.

39. A method comprising:
controlling transmission to user equipment in downlink direction by monitoring the amount of data to be transmitted to the user equipment and monitoring the time elapsed since the previous downlink transmission of the user equipment and allowing data transmission only when either result of monitoring exceeds a predetermined threshold; and
controlling transmission from user equipment in uplink direction by allowing the user equipment to start uplink transmission only when a given predetermined time interval has elapsed since the previous uplink transmission from the user equipment.

40. The method of claim 39, further comprising:
assigning a bearer to a user equipment, on which bearer transmission in downlink direction is controlled by a base station
monitoring the amount of data to be transmitted to the user equipment and
monitoring the time elapsed since the previous downlink transmission of the user equipment and
allowing data transmission only when either result of monitoring exceeds a predetermined threshold; and
on which bearer transmission in uplink direction is controlled by allowing the user equipment to transmit only when a given predetermined time interval has elapsed since the previous uplink transmission from the user equipment.

41. A method comprising:
receiving a command from a base station;
entering on the basis of the command a forced idle state, in which state the apparatus may request a connection only after a predetermined time interval has elapsed since previous transmission or if the amount of data to be transmitted by the apparatus is larger than a predetermined threshold.

42. A computer program embodied on a distribution medium, comprising program instructions which, when loaded into an electronic apparatus, control the apparatus to: control transmission to user equipment in downlink direction by monitoring the amount of data to be transmitted to the user equipment and monitoring the time elapsed since the previous downlink transmission of the user equipment and allowing data transmission only when either result of monitoring exceeds a predetermined threshold; and
control transmission from user equipment in uplink direction by allowing the user equipment to start uplink transmission only when a given predetermined time interval has elapsed since the previous uplink transmission from the user equipment.

43. A computer program embodied on a distribution medium, comprising program instructions which, when loaded into an electronic apparatus, control the apparatus to: enter on the basis of a command from a base station a forced idle state, in which state the apparatus may request a connection only after a predetermined time interval has elapsed since previous transmission or if the amount of data to be transmitted by the apparatus is larger than a predetermined threshold.
